(19) United States
(12) Patent Application Publication
(10) Pub. No.: US 2009/0079316 A1
(43) Pub. Date: Mar. 26, 2009

(54) OUTER ENVELOPE AND LAMP WITH OUTER ENVELOPE

(75) Inventors: Istvan Wursching, Erzsebet ter (HU); Sandor Lukacs, Nyar u. (HU); Erzsebet Cserteg, Erdosor u. (HU); Gyula Busai, Erkel Gyula u. (HU)

Correspondence Address: Fay Sharpe LLP, 1228 Euclid Avenue, 5th Floor, The Halle Building, Cleveland, OH, 44115-1843, US

(73) Assignee: General Electric Company

(21) Appl. No.: 11/859,612

(22) Filed: Sep. 21, 2007

(51) Int. Cl. H01J 61/52; H01J 61/04

(52) U.S. Cl. 313/25; 313/635

(57) ABSTRACT

An outer envelope for accommodating at least one light-emitting body and a control gear with electrical components is suggested, the outer envelope comprises
a wall at least partially of a glass material, in which
the glass wall of the outer envelope is covered with a coating of powder varnish of poly-ester-blocked isocyanate for uniform spherical luminous intensity distribution, protecting the envelope against mechanical shocks and providing for shatter containment.

A lamp with an outer envelope for accommodating at least one light-emitting body and a control gear with electrical components is also suggested.

An improved compact fluorescent lamp comprises a discharge tube arrangement, a ballast circuit, a base and a substantially bulb-shaped outer envelope. The substantially bulb-shaped outer envelope has a wall at least partially of a glass material, and comprises a substantially spherical portion enclosing at least a part of the discharge tube arrangement and an elongated end portion enclosing at least a part of the ballast circuit. The glass wall of the outer envelope is covered with a coating of powder varnish of polyester-blocked isocyanate for uniform spherical luminous intensity distribution, protecting the envelope against mechanical shocks and providing for shatter containment.

### FIELD OF THE INVENTION

This invention relates to an outer envelope and lamps with such an envelope, and more particularly to compact fluorescent lamps with this envelope that can replace incandescent lamps of general purpose.

### BACKGROUND OF THE INVENTION

Energy saving lamps for illuminating purposes generally comprise a light emitting body or light source with at least one protective cover or envelope. Such lamps include for example but not exclusively, low pressure discharge lamps and compact fluorescent lamps (CFL).

The prior art lamps are used in a wide variety of home and industrial applications. However, envelopes of these lamps are relatively fragile and often subject to breakage, especially in environments where the lamps are exposed to extreme temperatures or mechanical stress. Therefore, it is highly advantageous for the lamp to be protected such that the risk of breakage is reduced and the effect of any breakage is mitigated.

U.S. Pat. No. 5,864,202 suggests using an outer envelope made from plastic material, which provides sufficient protection against mechanical stress and shocks, however such a lamp remains sensitive with regard to high temperature. Further to this, outer envelopes made of a plastic material do not provide for sufficient output luminosity due to their relative high absorbance. Therefore it is preferred to use outer envelopes of a glass material with a protective cover guard enclosing the lamp envelope.

A lamp assembly in which a protective cover guard encloses a lamp envelope is known from U.S. Pat. No. 6,406,167. The cover guard according to this suggestion is a plastic hose that is placed over and encloses the lamp and extends partially over the lamp base. A rigid metal or plastic ring is placed over the cover guard at a location where the guard extends over the lamp base and has a smaller diameter than the base. The cover guard is subsequently sealed to the lamp base. Such a cover guard may only be used for fluorescent lamps with an elongated discharge tube with base section at the ends of the tube member. CFL-s typically have a more complex shape with more tubular members connected to each other or coiled tubes or a protecting outer envelope that may have the shape of a bulb in order to resemble a conventional incandescent lamp. Such a low-pressure discharge lamp with bulb shaped outer envelope is known from U.S. Pat. No. 6,064,155.

Also known is a CFL with a bulb shaped outer envelope, which has a protecting cover or sleeve of a silicon material. This silicon cover is formed on the outer surface of the outer envelope by dipping it into the fluid silicon paint and drying the paint afterwards. Such a silicon cover is highly elastic and does not attach to the outer wall of the envelope, therefore it may be torn and damaged easily. Although this silicon cover provides sufficient mechanical protection as long as not damaged, it will however reduce the intensity of emitted light due to its absorbing effect and not provide for a proper dispersion of light.

Low pressure discharge lamps and compact fluorescent lamps often have an uneven spatial light intensity distribution, which may be enhanced by using a light dispersing outer envelope. In order to achieve the desired effect, the outer envelope may be of a translucent or opaque glass or a plastic material. Another possible solution is the use of an outer envelope of a glass material with a light dispersing coating on the inside surface of the envelope. Such a light dispersing electrostatically deposited coating is known from U.S. Pat. No. 4,081,709. This lamp has an improved spatial light intensity distribution, which however depends on the evenness of the thickness and density of the deposited coating. Although this lamp may provide sufficient dispersion of light it is not protected against mechanical stress and shocks.

There is a need to provide an envelope for lamps with at least one light emitting body and a control gear with electrical components, which provides for sufficient light dispersion without unnecessarily reducing the intensity of light emitted by the lamp and sufficient protection against mechanical stress and shocks.

There is a further need to provide a lamp envelope, which will remain intact and contain the debris within thereof even after an impact strong enough to shatter the envelope completely. A further particular need is to provide a “safety” fluorescent lamp that is easy and inexpensive to manufacture.

### SUMMARY OF THE INVENTION

In an exemplary embodiment of the present invention, an outer envelope for accommodating at least one light-emitting body and a control gear with electrical components is suggested, which comprises
a wall at least partially of a glass material; and
the glass wall of the outer envelope is covered with a coating of powder varnish of polyester-blocked isocyanate for uniform spherical luminous intensity distribution, protecting the envelope against mechanical shocks and providing for shatter containment.

In an exemplary embodiment of another aspect of this invention, a lamp with an outer envelope for accommodating at least one light-emitting body and a control gear with electrical components is suggested. The outer envelope of the lamp comprises
a wall at least partially of a glass material; and
the glass wall of the outer envelope is covered with a coating of powder varnish of polyester-blocked isocyanate for uniform spherical luminous intensity distribution, protecting the envelope against mechanical shocks and providing for shatter contaminent.

According to an exemplary embodiment of still another aspect of the invention, a compact fluorescent lamp is suggested. The compact fluorescent lamp comprises a discharge tube arrangement, a ballast circuit, a base and a substantially bulb-shaped outer envelope. The discharge tube arrangement is formed of at least one discharge tube made of glass, encloses a discharge volume filled with a discharge gas, and has a fluorescent phosphor coating disposed on an inner surface of the tube. The tube forms a continuous arc path and is provided with electrodes disposed at each end of the arc path. The ballast circuit provides for controlling current in the tube and is connected to the electrodes and an associated power supply. The base has contact terminals for connecting said lamp to the associated power supply. The substantially bulb-shaped outer envelope has a principal axis and a wall at least partially of a glass material, and comprises a substantially spherical portion enclosing at least a part of the discharge tube arrangement and an elongated end portion enclosing at least a part of the ballast circuit. The glass wall of the outer envelope is covered with a coating of powder varnish of polyester-blocked isocyanate for uniform spherical luminous intensity distribution, protecting the envelope against mechanical shocks and providing for shatter containment.

The present invention has several advantages over the prior art. The outer envelope, a lamp with different light emitting bodies and a compact fluorescent lamp with such an outer envelope provide uniform spherical light intensity distribution without unnecessarily reducing the luminous intensity of the lamp and sufficient protection against mechanical stress and shocks. The suggested embodiments provide for an outer envelope with a very effective protection against scattering of glass fragments from the envelope in the event that the lamp breaks. Lamps with such a “safety” envelope are easy and inexpensive to produce and therefore well suited for mass production.

### BRIEF DESCRIPTION OF THE DRAWINGS

The invention will now be described in detail with reference to the enclosed drawing, in which

FIG. 1 is a cross sectional side view of a lamp with an outer envelope according to an embodiment of the invention,

FIG. 2 is a cross sectional side view of an outer envelope according to another embodiment of the invention,

FIG. 3 is a side view of a lamp according to an embodiment of the invention, partially in cross section,

FIG. 4 is a side view of a lamp according to another embodiment of the invention, partially in cross section,

FIG. 5 is a photo shot during a mechanical stress experiment with a steel ball hitting the surface of the outer envelope,

FIG. 6 is a photo shot during a mechanical stress experiment with a depression and a crack left behind after hitting the surface of the outer envelope.

### DETAILED DESCRIPTION OF THE INVENTION

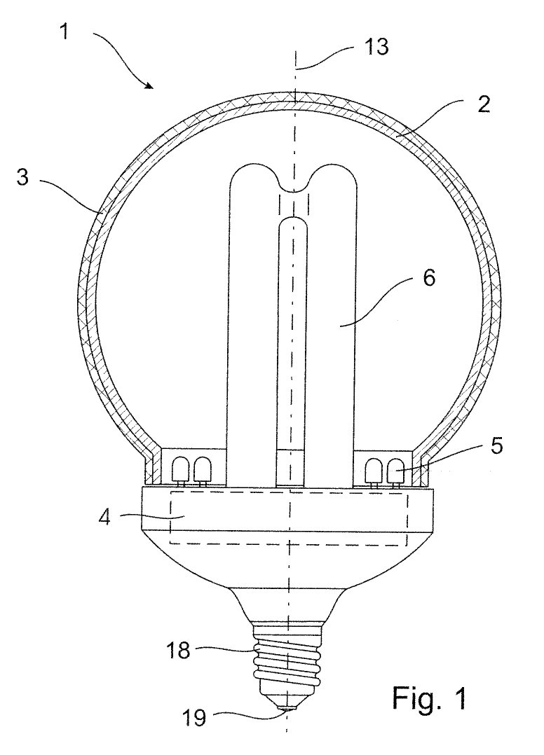

Referring first to FIG. 1, a first exemplary embodiment of a lamp 1 according to the invention is shown with an outer envelope 2 for accommodating at least one light-emitting body 5, 6 and a control gear 4 of electronic components for providing the at least one light emitting body with the necessary electric energy. The envelope 2 comprises a wall at least partially of a glass material and the glass wall of the outer envelope is covered with a coating 3 of powder varnish of polyester-blocked isocyanate for uniform spherical luminous intensity distribution, protecting the envelope against mechanical shocks and providing for shatter containment. Inside the outer envelope, there is shown a compact fluorescent lamp 6 in the middle and two light emitting diodes 5 (LED) on both sides of the CFL. As the LED-s 5 need a low voltage supply, a transformer will be used as a control gear 4 as well known in the art. LED-s may need a low voltage DC supply, therefore a DC power supply comprising at least a transformer and rectifying means such as a diode may be used as a control gear with electrical components. LED-s may also be supplied directly from a transformer supplying AC low voltage. When the combination of a CFL and LED-s is used as a light emitting body inside the outer envelope, the transformer may be a common transformer for both kinds of light emitting bodies. As shown in FIG. 1, the outer envelope 2 has the shape of a light bulb with a substantially spherical section for receiving at least a part of the light-emitting body and an elongated end section for receiving at least a part of the components of the control gear. As it may be apparent to those skilled in the art, the shape and material of the outer envelope may be selected to be different from the embodiment disclosed above without departing from the scope of the invention. The form of the outer envelope may be for example elliptical, cylindrical or it may have any other different form that is suitable for accommodating the light emitting body. The material of the outer envelope may be fully glass, or partly glass with plastic and or metallic supplemental components.

The protecting coating may be applied to an outside surface or an inside surface of the part of the outer envelope 2 that has a glass wall. The coating has a thickness preferably of 80 to 150, more preferably of 80 to 120 micrometers and even more preferably of 80 to 100 micrometers. The outer envelope may have a glass wall with a thickness of 0.5 to 1.5 millimeters. The coating may be applied to the wall of the outer envelope 2 by electrostatic depositing of the powder varnish after cleaning and drying the surface. The deposited powder varnish has to be cured in order to transform it from the powder form to a uniform pore free melted layer. The curing of the coating may be optimized as to the curing time in order to accelerate the production time or curing temperature in order to protect electronic components inside the envelope. The curing temperature and time may be selected within a range of 120 to 180° C. and 40 to 20 minutes, respectively. The powder varnish comprising polyester-blocked isocyanate is available for example from Egrokorr Festékipari Zrt. (Érd, Hungary).

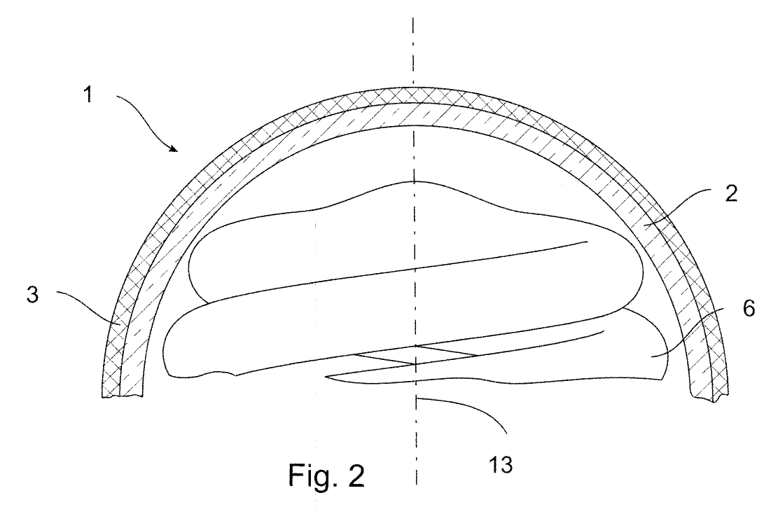

In a lamp comprising the above described outer envelope, the light emitting bodies may be selected from the group comprising low-pressure discharge tubes, LED-s and a combination thereof. In FIG. 1, a combination of a CFL and two pair of LED-s are depicted as light emitting bodies, and in FIG. 2, a low-pressure discharge tube is shown as a light emitting body. As a low-pressure discharge tube comprises a glass wall, the protecting cover of the outer envelope provides a mechanical protection for the glass wall of the light emitting bodies as well. As already disclosed above, the form of the outer envelope may be bulb shaped, elliptical, cylindrical, or it may have any other different form that is suitable for accommodating the light emitting body. The material of the outer envelope may be fully glass, or partly glass with plastic and metallic supplemental components. The metal component part may be for example a base component with contact terminals for connecting said control gear of electrical components to a power supply.

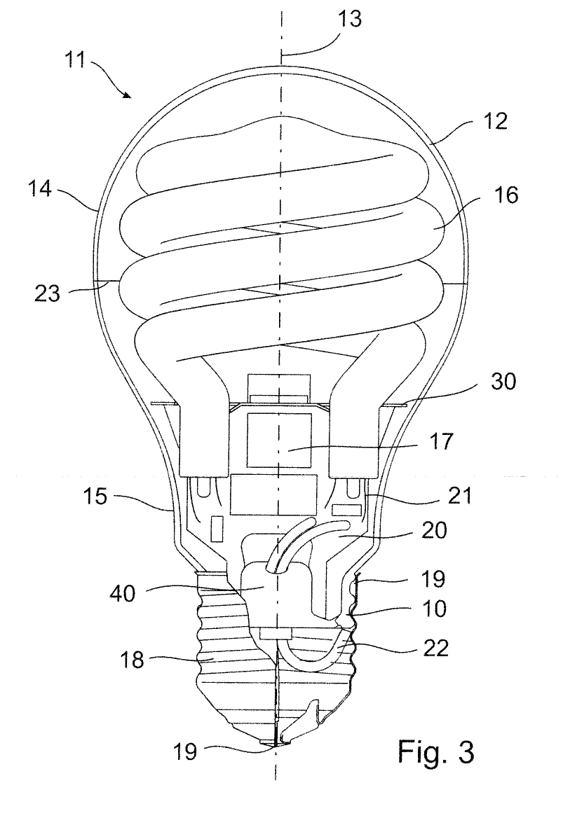

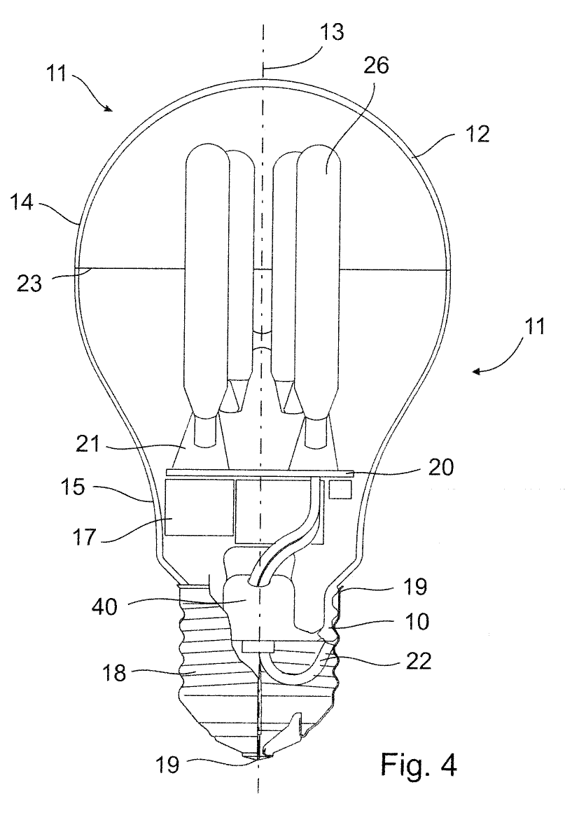

Referring now to FIGS. 3 and 4, a compact fluorescent lamp 11 with an outer envelope 12 as described in detail in connection with FIGS. 1 and 2 is shown. The compact fluorescent lamp 11 comprises a discharge tube arrangement 16, 26, a ballast circuit 17, a substantially bulb-shaped outer envelope 12 and a base. The discharge tube arrangement 16, 26 is formed of at least one discharge tube made of glass, encloses a discharge volume filled with a discharge gas, and has a fluorescent phosphor coating disposed on the inner surface of the tube. The tube forms a continuous arc path and it is provided with electrodes disposed at each end of the arc path. The ballast circuit 17 provides for controlling current in the tube, and is connected to electrodes and an associated power supply. The substantially bulb-shaped outer envelope 12 with a principal axis 13, has a wall at least partially of a glass material and comprises a substantially spherical portion 14 enclosing at least a part of the discharge tube arrangement 16, 26 and an elongated end portion 15 enclosing at least a part of the ballast circuit 17. The base 18 has contact terminals 19 for connecting the ballast circuit 17 to the associated power supply. The glass wall of the outer envelope 12 is covered with a coating of powder varnish comprising polyester-blocked isocyanate for uniform spherical luminous intensity distribution, protecting the envelope against mechanical shocks and providing for shatter containment. The powder varnish is applied to the glass wall of the outer envelope of the CFL in the same way as already described in detail in connection with the outer envelope shown in FIGS. 1 and 2, however it may be deposited only on the outer surface of the envelope.

The discharge tube arrangement 16, 26 may comprise a single discharge tube or a plurality of elongated discharge tubes. The ends of the tubes are sealed in a gas tight manner. The discharge tube arrangement 16, 26 is connected to the ballast circuit 17 for controlling the current in the discharge tubes through lead-in wires 21. The ballast circuit 17 is further connected to an associated power supply through lead-out wires 22 which are connected to contact terminals 19 in the lamp base 18. As shown in FIGS. 3 and 4, the open end of the neck portion 10 of the outer envelope 12 is closed and terminated by a closing means 40 with a tubular opening. The lead-out wires 22 are isolated from each other and led through the tubular opening to the base 18 for connecting the lamp to the associated power supply through a socket. The lamp base is configured to be adapted to a socket, which may be of any conventional type normally used for lamps. FIGS. 3 and 4 show a screw-in base 18, however the lamp base may be configured to fit in either a screw-type socket or a bayonet socket.

The ballast circuit 17 is mounted on a printed circuit board, which has an orientation substantially parallel to the principal axis 13 of the lamp. The edge of the printed circuit board carrying the ballast circuit 17 has advantageously similar boundary form as a longitudinal cross section of the wall of the outer envelope 12 taken in a plane parallel to the principal axis 13 of the lamp 11 but with an offset which is defined by the dimensions of the closing means and the discharge tube as it is best seen in FIG. 3. The printed circuit board of the ballast circuit may, however, have a different orientation. In the embodiment shown in FIG. 4, the orientation of the printed circuit board of the ballast circuit is perpendicular to the principal axis of the lamp.

In the embodiments shown in FIG. 3 and 4, the light emitting body is a low-pressure discharge tube with a relatively large dimension and therefore it cannot be inserted into the outer envelope through the open end of the neck portion. The outer envelope therefore is comprised of two parts separated along a circumferential line 23 in a plane substantially perpendicular to the principal axis 13 of the envelope 12. The two parts include an upper part for receiving a part of the discharge tube arrangement 16 and a lower part for receiving the remaining part of the discharge tube arrangement 16 and at least a part of the ballast circuit 17. The two parts of the envelope are connected and sealed to form a uniform bulb shaped envelope 12. The circumferential separation line 23 of the outer envelope 12 may be in a region where the wall of the envelope has a substantially cylindrical form. In the shown embodiments, the separation line is at the widest region of the spherical portion of the outer envelope in order to use a relatively large discharge tube that can fill a maximum of the inner volume of the outer envelope. This helps to preserve the relatively small size of a conventional incandescent lamp and to achieve a relatively high luminous output of a relatively large discharge tube. In order to provide a uniform coating on the glass wall of the outer envelope, the coating has to be applied on the outer surface after assembling and resealing the two parts of the bulb shaped outer envelope. To avoid thermal shock or overheating of the electronic component inside the outer envelope, the curing temperature should be selected as low as possible, preferably at about 120° C.

In the embodiment shown in FIG. 3, the compact fluorescent lamp comprises a discharge tube arrangement 16 of a tube with substantially straight end sections and an intermediate portion between the end sections. The end sections are at one end of the tube arrangement and substantially parallel to each other and the intermediate portion has a coiled configuration wound about the principal axis 13 of the lamp. The discharge tube arrangement 16 and the printed circuit board 20 are held within the outer envelope and relative to each other by a holding and protecting shield 30, which is oriented in a plane substantially perpendicular to the principal axis 13 of the lamp. The holding and protecting shield 30 comprises a receiving and fixing portion for the discharge tube arrangement 16 and the printed circuit board 20 of the ballast circuit 17 and provides sufficient protection against mechanical vibration and shocks.

Alternatively, the discharge tube arrangement 26 may be comprised of four straight members with a longitudinal axis substantially parallel to the principal axis of the compact fluorescent lamp, in which the straight tube members are connected to each other in series to form a continuous arc path as shown in FIG. 4. Possible arrangements include also configurations with two or six individual discharge tube members depending on the required output luminous intensity. The discharge tube arrangement may also comprise two individual, elongated discharge tube members bent in an U-shape of substantially the same length, which are interconnected by a bridge to form a continuous arc path. Possible arrangements include also configurations with one or three individual discharge tubes bent in an U-shape depending on the required output luminous intensity. The U-shaped discharge tube members may comprise substantially parallel straight sections defining the length of the discharge tube arrangement and a curved middle section.

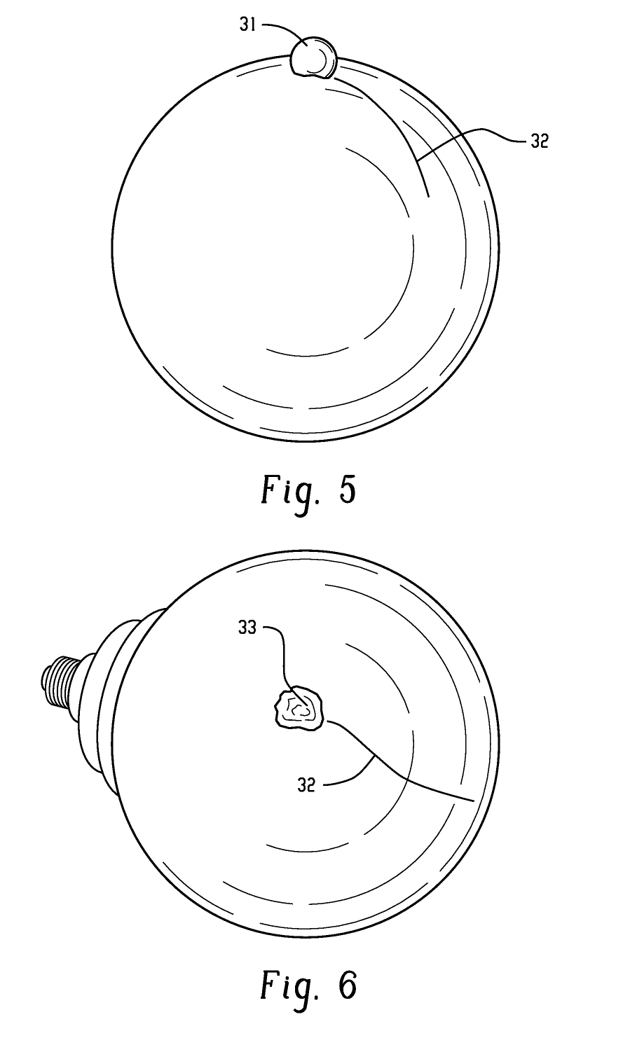

After manufacturing a compact fluorescent lamp with an outer envelope having a wall of a glass material and with a protecting coating on the outside surface of the glass wall of the outer envelope, a mechanical stress experiment was carried out as shown in FIGS. 5 and 6. In the experiment, a steel ball was used with an outer diameter of 8 mm and a weight of about 75 g. The steel ball was held above the outer envelope at a distance of 1 meter and dropped thereon. As seen in FIG. 5, the steel ball 31 hit the outer envelope and did not break it into pieces as it could have been expected in case of a glass envelope without protecting coating. The steel ball 31 after hitting the surface of the outer envelope with the protecting cover of the invention left behind a depression 33 with broken edges and a crack 32 of about 5 cm length in the glass wall as it can be seen in FIG. 6 but the glass wall of the outer envelope stayed in one piece and no shatter was dispersed.

The invention has been disclosed with reference to the drawings, however it might be apparent to those skilled in the art that it is not limited to the shown and disclosed embodiments, but other elements, improvements and variations are also within the scope of the invention. For example, it is clear that a number of other forms of the outer envelope, discharge tube and base may be applicable for the purposes of the present invention. For example, the envelope may have a globe-shape or a T-shape. The number and form of discharge tube members within a lamp may also vary according to size or desired power output of the lamp. The base shell used for providing electrical connection to a power supply may also be selected from any standard or non-standard type.

1. An outer envelope for accommodating at least one light-emitting body and a control gear with electrical components, the envelope comprising
a wall at least partially of a glass material; and
the glass wall of the outer envelope being covered with a coating of powder varnish of polyester-blocked isocyanate for uniform spherical luminous intensity distribution, protecting the envelope against mechanical shocks and providing for shatter containment.

2. The outer envelope of claim 1, in which the coating is applied to an outside surface of the glass wall.

3. The outer envelope of claim 1, in which the coating is applied to an inside surface of the glass wall.

4. The outer envelope of claim 1, in which the coating has a thickness of 80-150 micrometers.

5. The outer envelope of claim 1, in which the coating has a thickness of 80-120 micrometers.

6. The outer envelope of claim 1, in which the coating has a thickness of 80-100 micrometers.

7. The outer envelope of claim 1, in which the glass wall of the outer envelope has a thickness of 0.5-1.5 millimeters.

8. The outer envelope of claim 1, in which the coating is electro-statically deposited on the glass wall of the outer envelope.

9. The outer envelope of claim 8, in which the coating has a curing temperature and time in the range of 120 to 180° C. and 40 to 20 minutes, respectively.

10. A lamp with an outer envelope for accommodating at least one light-emitting body and a control gear with electrical components, the outer envelope comprising
a wall at least partially of a glass material; and
the glass wall of the outer envelope being covered with a coating of powder varnish of polyester-blocked isocyanate for uniform spherical luminous intensity distribution, protecting the envelope against mechanical shocks and providing for shatter containment.

11. The lamp of claim 10, in which the at least one light emitting body is selected from the group consisting of low-pressure discharge tubes, LEDs and a combination thereof.

12. The lamp of claim 10, in which the outer envelope partially comprises a plastic material.

13. The lamp of claim 10, in which the outer envelope comprises a metal component part.

14. The lamp of claim 13, in which the metal component part is a base component.

15. A compact fluorescent lamp comprising
a discharge tube arrangement, said discharge tube arrangement being formed of at least one discharge tube made of glass, enclosing a discharge volume filled with a discharge gas, and having a fluorescent phosphor coating disposed on an inner surface of the tube, the tube forming a continuous arc path and further being provided with electrodes disposed at each end of the arc path;
a ballast circuit for controlling current in the tube and being connected to the electrodes and an associated power supply;
a base with contact terminals for connecting said lamp to the associated power supply;
a substantially bulb-shaped outer envelope with a principal axis, having a wall at least partially of a glass material and comprising a substantially spherical portion enclosing at least a part of the discharge tube arrangement and an elongated end portion enclosing at least a part of the ballast circuit;
the glass wall of the outer envelope being covered with a coating of powder varnish of polyester-blocked isocyanate for uniform spherical luminous intensity distribution, protecting the envelope against mechanical shocks and providing for shatter containment.

16. The compact fluorescent lamp of claim 15, in which the outer envelope is comprised of two parts separated along a plane substantially perpendicular to the principal axis of the envelope, the two parts of the envelope being connectable and sealable to form a uniform bulb shaped envelope.

17. The compact fluorescent lamp of claim 15, in which the discharge tube arrangement a is comprised of a single tube with substantially straight end sections and an intermediate portion between the end sections and the end sections being at one end of the tube arrangement and in proximity to each other and the intermediate portion having a coiled configuration wound about the principal axis of the lamp.

18. The compact fluorescent lamp of claim 15, in which the discharge tube arrangement is comprised of straight tube members with a longitudinal axis substantially parallel to the principal axis of the fluorescent lamp and the straight tube members being connected to each other in series to form a continuous arc path.

19. The compact fluorescent lamp of claim 15, in which the coating is applied to an outside surface of the glass wall.

20. The compact fluorescent lamp of claim 19, in which the coating is electrostatically deposited on the glass wall of the outer envelope.

21. The compact fluorescent lamp of claim 20, in which the coating has a curing temperature and time in the range of 120 to 180° C. and 40 to 20 minutes, respectively.
